(19) United States
(12) Patent Application Publication
(10) Pub. No.: US 2004/0109459 A1
(43) Pub. Date: Jun. 10, 2004

(54) Packet filter provisioning to a packet data access node

(76) Inventors: Lila Madour, Kirkland (CA); Ghyslain Pelletier, Lulea (SE)

Correspondence Address: ALEX NICOLAESCU, Ericsson Canada Inc., Patent Department, 8400 Decarie Blvd., Montreal, QC, H4P 2N2, CA

(21) Appl. No.: 10/625,728

(22) Filed: Jul. 24, 2003

Related U.S. Application Data
(60) Provisional application No. 60/398,560, filed on Jul. 25, 2002.

(51) Int. Cl. H04L 12/56

(52) U.S. Cl. 370/401; 370/389

(57) ABSTRACT

A method, Proxy-Call State Control Function (PCSCF) and packet data network for creating packet filters for data flow mapping in the P-CSCF, and for their transmission to a Packet Data Access Node (PDAN) such as a Packet Data Service Node (PDSN) of a CDMA2000 network. A packet data session is setup between a terminal such as Mobile Station (MS) and a Corresponding Node (CN) using Session Initiation Protocol (SIP). The P-CSCF gathers information related to the IP address and port numbers of the parties, of the data flows for the data session, as well as of the service instances between the terminal and the PDAN. Based on this information, the P-CSCF creates a filter for mapping each data flow from the CN to the available service instances. The filter is sent to the PDAN, which installs and uses the filter and performs appropriate routing of the incoming data flows.

### PRIORITY STATEMENT UNDER 35 U.S.C. S.119(e) & 37 C.F.R. S.1.78

This non-provisional patent application claims priority based upon the prior U.S. provisional patent application entitled “SIGNALLING OF PACKET FILTERS VIA P-CSCF IN IP MMED DOMAIN”, application No. 60/398,560, filed Jul. 25, 2002, in the names of Lila MADOUR and Ghyslain PELLETIER.

### BACKGROUND OF THE INVENTION

1. Field of the Invention

The present invention relates to a method and system for supporting multiple service instances for a mobile station in a packet data network.

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a 3rd Generation (3G) mobile wireless technology allowing mobile users to access IP-based high-speed voice and data traffic over the CDMA-based cellular network. Characteristically, CDMA2000 can support mobile data communications at speeds ranging from 144 kbps to 2 Mbps.

A typical CDMA2000 network comprises a number of nodes including one or more Mobile Stations (MSs), one or more Base Stations (BSs), one or more Packet Control Functions (PCFs) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSNs. In order to provide IP Multimedia Services (MMS) to the MS subscribers over the CDMA2000 wireless system, a Session Initiation Protocol (SIP) server, or a Call Switch Control Function (CSCF) is also required.

SIP is an Internet Engineering Task Force (IETF) standard protocol for initiating an interactive user session that may involve multimedia elements such as video, voice, chat, gaming, and virtual reality. Like the Hyper Text Transfer Protocol (HTTP) and the Simple Mail Transfer Protocol (SMTP), SIP works in the application layer of the Open Systems Interconnection (OSI) communications model. SIP can establish multimedia sessions or Internet telephony calls, modify, or terminate them, on top on an existing network such as the CDMA2000 network. SIP can also invite participants to unicast or multicast sessions that do not necessarily involve the initiator. Because SIP supports name mapping and redirection services, it makes it possible for users to initiate and receive communications and services from any location, and for networks to identify the users wherever they are. SIP is a request-response protocol, dealing with requests from clients and responses from servers. Participants are identified by SIP Uniform Resource Locators (URLs). Requests can be sent through any transport protocol, such as the User Datagram Protocol (UDP), the Simple Control Transport Protocol (SCTP), or the Transfer Control Protocol (TCP). SIP determines the end system to be used for the session, the communication media and media parameters, and the called party's desire to engage in the communication. Once these are assured, SIP establishes call parameters at either end of the communication, and handles call transfer and termination. SIP is specified in IETF Request for Comments RFC 2543, and RFC 3261, both of which are herein included by reference.

In the CDMA 2000 network, the PDSN provides access to the Internet, intranets and applications servers for mobile stations utilizing the CDMA2000 RAN. Acting as an access gateway, the PDSN provides simple IP and mobile IP access, foreign agent support, and packet transport for virtual private networking. It acts as a client for an Authorization, Authentication, and Accounting server (AAA) and provides mobile stations with a gateway to the IP network.

Finally, a Proxy CSCF (P-CSCF) is the terminals' point of contact in the serving network once the MS' registration has taken place. One of the primary functions of the P-CSCF is to be the Quality of Service (QoS) policy enforcement point within the visited IP Multimedia Subsystem (MMS) network, i.e. the point where the network places constraints on the bearer. The MS registers and initiates sessions via the P-CSCF, which proxies all MS' requests to a Serving CSCF (S-CSCF) responsible for identifying the MS user's service privileges, for selecting access to the home network application server (service platform) and for providing access to that server. One of the primary functions of the S-CSCF is to perform session management for the MMS network. The S-CSCF of the home network is responsible for the session control, but depending of the particular implementation, may forward specific requests to a P-CSCF in the visited/serving network based on the requirements of the requests.

The AAA server of the CDMA2000 network intelligently controls access to network resources, enforces policies, audits the usage, and provides the information necessary to bill for the services accessed by the MSs. These combined processes are essential for effective network management and security.

In some situations, an MS may instantiate a generic packet data service at the beginning of a packet data session established with a serving PDSN, and may use the service as a primary connection, also herein called primary service instance with the serving PDSN. When the requested service requires a higher bandwidth, or a better Quality of Service (QoS) than the one provided solely by the primary service instance, the MS may request one or more additional service instances, herein called auxiliary service instances or connections, in order to fulfill the need for the greater bandwidth or QoS. Such situations may occur, for example, when requesting a multimedia session, a video conference call, a file download or upload, or with any other real-time application. For example, in current CDMA2000 networks, 3GPP2 standard recommendation specifies that up to six (6) different service instances may be established for exchanging data over a packet data session between a PDSN and a serviced MS, as per the need of the application launched on the MS. Two (2) more service instances may also be reserved for control signalling between the same PDSN and MS. Each one of the established service instances is typically identified within the PDSN and the MS by a Service Reference Identifier (SRID). The allocation of the appropriate number of service instances is performed by the PDSN during the call setup, as per the request of the MS, or alternatively during an ongoing data call.

An auxiliary connection may be defined for data traffic having more specific requirements (QoS-related information such as the data bandwidth, error rates, delays, etc.) and thus provides a more specialized packet data service. Such an auxiliary service instance in an IP Multimedia environment is typically instantiated at the MS via SIP signalling used to set up a multimedia session, because this signalling contains sufficient information about the identity of the forward data flow to allow for the auxiliary service instances to be created (e.g. information such as the originating and terminating IP address/port number).

Data packets heading from the serving PDSN towards the MS may be assigned to particular one of the available service instances based on the QoS requirements for that particular data flow. This may be achieved using flow routing information associated to the service instance. In some wireless standards, this information is referred to as a Traffic Flow Template (TFT) and comprises packet filters for each data flow. In the current prior art implementations, the MS sends this information directly to the serving PDSN in the access network using any known QoS mechanism. A data packet sent from the PDSN to the MS that does not match a packet filter may be defaulted to the primary service instance.

Thus, a TFT contains packet filters for mapping a data packet to a service instance. Each filter may contain parameters useful for associating a packet with a particular data flow for which a service instance is assigned. Such filters may take various forms, and for example, may contain the source IP address, and source port number for the associated data flow, but may further contain the destination IP address and port number, as well as, for example, Real Time Protocol (RTP) parameters for the particular data flow. A filter may also include other flow treatment information such as header compression, payload compression or encryption.

Current standards in 3GPP and 3GPP2 rely on the MS to signal the packet filters to the packet data serving node (e.g. PDSN in CDMA2000 networks, or Gateway GPRS Support Node (GGSN) in the Enhanced Development for GSM Environment (EDGE) and Wide-CDMA networks). However, with the emerging IP Multimedia architecture in the wireless domain, a large amount of requirements are and will be put on the MSs. For example, it is required that the MS provide an ever-increasing processing power as well as to support more than one service instances or service options to cater for the QoS needs of a particular application. In the current prior art implementations packet filters are signalled from the MS to the network, and this approach puts an additional burden on the MS' resources.

Accordingly, it should be readily appreciated that in order to avoid the involvement of the MS in the distribution of the packet filters to the PDSN, it would be advantageous to have a mechanism enabling easy and seamless distribution of these packet filters to the PDSN without requiring the intervention of a separate signaling sequence from the MS. The present invention provides such a solution.

### SUMMARY OF THE INVENTION

It is an object of the present invention to provide a method for provisioning a Packet Data Access Node (PDAN) with a packet filter for mapping one or more incoming data flows destined to a terminal to one or more service instances established between the PDAN and the terminal, the method comprising the steps of:

a) creating the packet filter in a Proxy-Call State Control Function (P-CSCF);

b) transmitting the packet filter from the P-CSCF to the PDAN; and

c) installing the packet filter in the PDAN.

It is another object of the present invention to provide a Proxy-Call State Control Function (P-CSCF) for provisioning a Packet Data Access Node (PDAN) with a packet filter for mapping one or more incoming data flows destined to a terminal to one or more service instances established between the PDAN and the terminal, the P-CSCF acting to create the packet filter and to transmit the packet filter to the PDAN.

It is yet another object of the present invention to provide a packet data network comprising:

a Packet Data Access Node (PDAN); and

a Proxy-Call State Control Function (P-CSCF) creating a packet filter for mapping one or more incoming data flows destined to a terminal to one or more service instances established between the PDAN and the terminal, and transmitting the packet filter to the PDAN;

wherein upon receipt of the packet filter, the PDAN installs the packet filter.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a nodal operation and signal flow diagram of an exemplary packet data network implementing the preferred embodiment of the present invention associated with an origination of a packet data session by a Mobile Station (MS); and

FIG. 2 is an exemplary high-level illustration of a packet data filter for use by the PDSN.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention takes advantage of the IP multimedia architecture and the involvement of a Proxy SIP server (SIP), which can take the form of a Proxy Call Switch Control Function (P-CSCF), in the data session setup in order to signal the appropriate packet filters to the PDSN in the context of a packet data session with multiple service instances, at the time the auxiliary instance(s) is/are requested by the MS. During the setup of the packet data service, the MS signals the P-CSCF with a set of data session requirements that may take the form of Session Description protocol (SDP) parameters. Based on these requirements, and once the bearer resources reservation is completed, the P-CSCF is capable to deduct which type and how many service instances are required for the requested packet data service, and to create corresponding packet filters allowing the PDSN to map the incoming data flows to each available service instance available with the MS. The P-CSCF can then send the packet filters to the PDSN, which installs said filters and maps the incoming data flows to each available service instance.

Originating Session Establishment

According to a first preferred embodiment of the present invention, the packet filters for data flow mapping in the PDSN can be transmitted for use with a data session originated by the MS. When an MS initiates such a data session, the PDSN has knowledge of which P-CSCF the MS uses. In order to establish the session, the MS issues a SIP INVITE messages, which is received by the P-CSCF, and forwarded to the destination party, herein called the Corresponding Node (CN). The original INVITE message from the MS, or subsequent SIP 100 or SIP 183 messages exchanged during the session setup contain session description parameters, such as SDP information, about the destination. The P-CSCF processes this information and sends the messages to the MS. Based on the session requirements, the MS establishes the appropriate auxiliary service instance(s) with the PDSN via the Radio Access Network (RAN). The PDSN then indicates to the P-CSCF that a bearer is established for the originating session, and the identity of the established service instances is included in the message sent from the PDSN to the P-CSCF, which then sends a response back to the PDSN acknowledging the setup of the bearer and includes in its response packet filters for mapping the incoming data flows to the existing service instances. The packet filters may include information embedded in the SIP messages, such as for example the originating IP address of the data flows, the port numbers of the originating data flows, and possibly the destination IP address of the data flows, and the destination party port numbers. The PDSN receives the packet filters and proceeds to their installation. When it receives the incoming data flows with data packets corresponding the packet filter signalled by the P-CSCF, it forwards the data flows to the corresponding service instance.

If a new data session is established for the same call, a new packet filter may be installed in the PDSN. Using signalling similar to the one described hereinabove, the P-CSCF indicates that a packet filter addition operation is requested. Similarly when a SIP BYE message is received by the P-CSCF for terminating a particular session, the P-CSCF signals to the PDSN that the packet filter(s) shall be removed using a packet filter deletion operation.

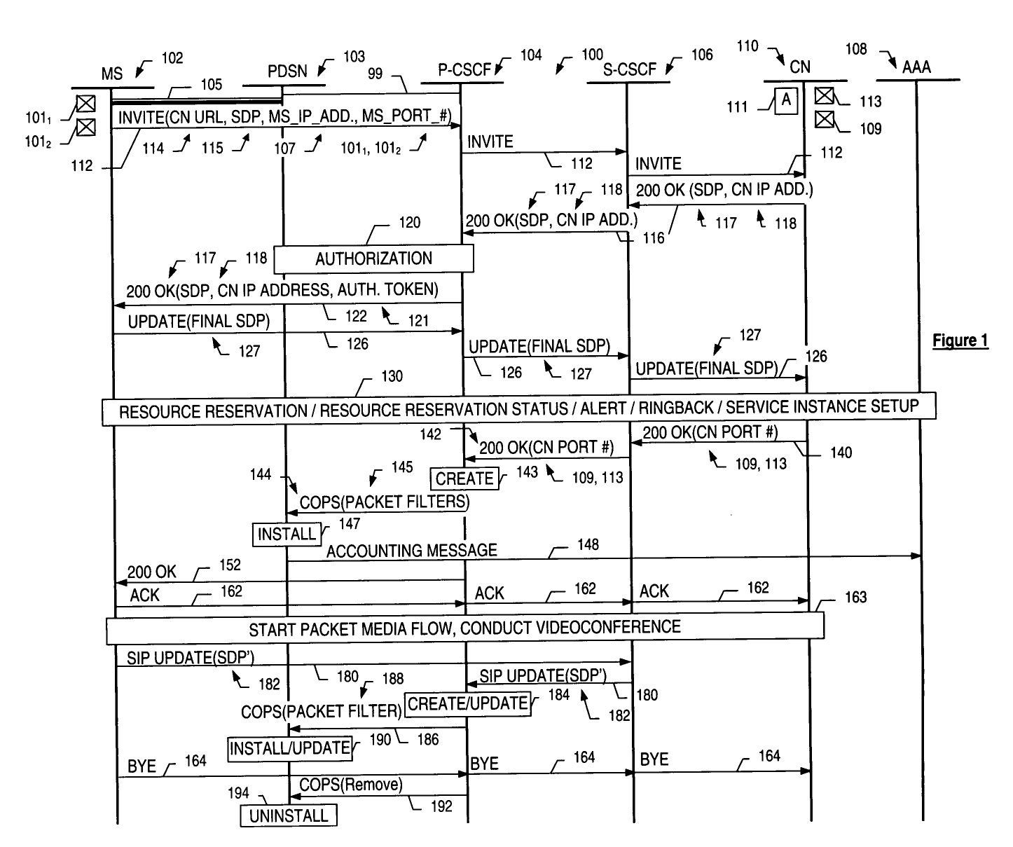

Reference is now made to FIG. 1, which is a nodal operation and signal flow diagram of an exemplary packet data network 100 implementing the preferred embodiment of the present invention associated with the origination of a packet data session by an MS 102. The exemplary network 100 may be a CDMA2000 network that comprises the MS 102 receiving wireless service via a Packet Data Service Node (PDSN) 103, and that may function according to the standard 3GPP2 P.S0001 - TIA/EIA IS-835 CDMA2000 Wireless IP, herein included by reference. Further, it is assumed for the present exemplary scenario that the MS 102 is connected to the PDSN 103 via a Point-to-Point Protocol (PPP) session 105 as known in the art, and that it can support IP MultiMedia Services (MMS) via a Proxy Call State Control Function (P-CSCF) 104 and a Serving Call State Control Function (S-CSCF) 106. Finally, an Authentication, Authorization and Accounting (AAA) server 108 is responsible for the charging with respect to the packet data traffic within the network 100. The MS 102 is also assumed to be able to establish packet data sessions with a Corresponding Node (CN) 110 that runs at least an application 111, that may be for example a multimedia application generating two data flows toward one or more network entities external to the CN. The first flow may be a video data flow output on a CN's port number 109, and the second flow may be a voice data flow output on the CN's port number 113.

According to the present invention, it is also assumed that a packet data communication interface 99 is defined and exists between the PDSN 103 and the P-CSCF 104, as it is currently being discussed by the 3GPP2. The present invention takes advantage of the present interface 99 by allowing the packet filters for the PDSN 103 to be transmitted from the P-CSCF 104.

With reference being further made to FIG. 1, the originating party, i.e. the MS 102, initiates, for example, a videoconference data session via the establishment of an MMS data session with the CN 110 using the Session Initiation Protocol (SIP), by issuing a SIP INVITE message 112 comprising a CN Uniform Resource Locator (URL) 114 identifying the CN, its own IP address 107, the identity of the MS port numbers 101, and 1012 that are to be used to exchange the video and voice data flows associated with the requested videoconference, as well as parameters descriptive of the session requirements, such as for example Session Description Protocol (SDP) parameters 115 comprising the requested media types and formats for the data session as well as session information such as session identification, requirements, QoS, network type, address type and address elements. The INVITE message 112 is sent to the P-CSCF 104, which may be determined via a CSCF discovery mechanism, as it is known in the art. In GPRS-based networks, this is achieved using DHCPv6 as specified in the standard set by the Internet Engineering Task Force (IETF) specification draft-ietf-dhc-dhcpv6 along with the options for SIP servers from the IETF specification draft-ietf-sip-dhcpv6, both of which are herein included by reference. Alternatively, the CSCF discovery mechanism may include transferring the P-CSCF address(es) within the PDP context activation procedure, or any other suitable procedure.

The P-CSCF 104 forwards the message 112 to the S-CSCF 106, which in turn validates the service profile of the MS 102 (action not shown), and performs any origination service control required for the MS (action not shown). This may include authorization of the requested SDP session parameters based on the MS 102 user's subscription for MMS. The S-CSCF 106 further relays the SIP INVITE message 112 to the CN 110, which in order to accept the data session, may respond with a SIP 200OK message 116 transmitted via the S-CSCF 106 to P-CSCF 104 and comprising, for example, a new set of desired SDP media stream capabilities 117 specified by the CN 110 as well as the CN IP address 118.

At least one of the INVITE message 112 and the 200 OK messages 116 comprise session description information that contains information about the data flows associated with the requested videoconference data session. For example, assuming that the MS 102 has requested the establishment of a multimedia videoconference connection with the CN 110 like in the present scenario, the data flows may be a first video data flow for exchanging video information between the MS 102 and the CN 110, and a second voice data flow for exchanging voice information between the same parties. In action 120, the P-CSCF 104, possibly in combination with the PDSN 103, authorizes the resources necessary to the data session (including the voice and video data flows) and may further generate, as a result of the authorization 120, an authorization token 121 associated with the authorized data flows for the session. The authorization token 121, is then forwarded in a 200 OK message 122 to the originating MS 102 along with the SDP media stream capabilities 117, and the CN IP address 118. Based on the SDP media stream capabilities 117 specified by the CN 110 and received in message 122, the MS 102 can decide the final set of media streams settings for the data session, and may send a SIP UPDATE message 126 with the final SDP parameters 127, via the P-CSCF 104 and the S-CSCF 106, to the CN 110.

In action 130, the MS 102 initiates the reservation procedures for the bearer resources needed for this data session. Part of action 130, when the bearer resources' reservation is completed, the MS 102 sends a resource reservation successful message to the termination endpoint, i.e. to the CN 110, via signalling established by the SIP INVITE message 112. The resources reservation successful message is also sent through the P-CSCF 104 and the S-CSCF 106 to the CN 110, which may optionally perform ringing/alerting, in which situation it signals to the MS 102, via the S-CSCF 106 and the P-CSCF 104, a provisional response indicating ringing.

Part of action 130 is also the establishment between the MS 102 and the PDSN 103 of one or more service instances, that may include one primary service instance and one or more auxiliary service instances. For example, in the present scenario it is assumed that in order to carry out the requested videoconference data session service, the MS 102 has requested and obtained the establishment, between the PDSN 103 and itself, of one primary service instance identified by a first SRID₁, and of another auxiliary service instance identified by a second SRID₂.

When the CN 110 answers, it sends a SIP 200 OK final response 140 to the S-CSCF 106, the message 140 containing the CN's port numbers 109 and 113 used for sending the video and voice data flows associated with the videoconference. The S-CSCF 106 may perform any further service control that is appropriate for the session setup and, when completed, sends a SIP 200OK final response 142 to the P-CSCF 104 with the same CN port numbers 109 and 113.

At this time, the P-CSCF 104 has knowledge of the SRID₁ and SRID₂ that identify the available service instances between the MS 102 and the PDSN 103 and which were received by the P-CSCF 104 in action 130, and also has knowledge of the video and voice data flows that are to be transmitted over the data session, from action 120. Furthermore, the P-CSCF 104 also has knowledge of the IP addresses of the MS 102 and of the CN 110, and of the port numbers utilized by each of them for outputting the data flows associated with the requested service. Having this knowledge, the P-CSCF may create, action 143, a set of packet filters 145 for mapping the data flows coming from the CN 110 with the available service instances set-up between the MS 102 and the PDSN 103.

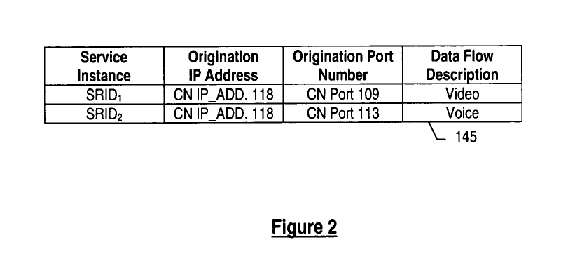

Reference is now made to FIG. 2, which shows an exemplary packet filter 145 for use by the PDSN 103 for data flow mapping, wherein:

the video data flow coming from the port number 109 of the CN 110 having the IP address 118 and being intended for the MS 102, is mapped by the PDSN 103 to the service instance identified by SRID₁; and

the voice data flow coming from the port number 113 of the CN 110 having the IP address 118 and being intended for the MS 102, is mapped by the PDSN 103 to the service instance identified by SRID₂.

With reference being now made back to FIG. 1, in message 144, the P-CSCF 104 transmits to the PDSN 103 via, for example, a Common Open Policy Service (COPS) Protocol message that comprises the packet filter(s) 145, and in action 147 the PDSN 103 installs the filters 145. In one variant, the COPS message 144 may be a COPS DECISION message comprising an Install command for the packet filters 145, although it is understood that the message 144 may be of any other type as well, such as for example but not limited to a DIAMETER or a RADIUS message type.

The PDSN 103 then starts metering the data session, and depending upon the type of requested accounting, it sends an Accounting Start message 148 to the AAA server 108 for informing the former of the new data session that is being established.

The P-CSCF 104 releases a SIP 200OK final response message 152 to the origination MS 102, which then starts the media flows for the present videoconference packet data session. The videoconference session is started, action 163, as the MS 102 sends acknowledgment message 162 to the CN 110.

According to the present invention, it is also possible to modify the filters 145 set up in the PDSN 103 if one of the involved parties, e.g. the MS 102 desires so. For example, at one point during the videoconference session, the MS 102 may desire to launch a chart board application in addition to the ongoing videoconference that involves voice and video. For this purpose, the MS 102 issues a SIP UPDATE message 180 with a modified set of session description parameters, such as modified SDP parameters 182, indicative of the request for the addition of the chat board service. The P-CSCF 104 receives the SIP UPDATE message 180 via the S-CSCF 106 and in action 184 creates a new packet filter 188, or updates the existing packet filter 145 to map the new, yet to be created, data flow associated with the chat board service on one of the existing service instances. The packet filter may have the form of the previously described packet filter 145 of FIG. 2, except for the he fact that it contains one more record for matching the new chart board data flow with an origination port number, origination IP address and service instance identifier. It is to be noted that at this time a new service instance may also be created for the new data flow. In action 186 the P-CSCF 104 sends to the PDSN 103 the new set of packet filter 188, and the PDSN 103 proceeds in action 190 to the installation of the new packet filter. Following action 190, the chat board data flow may travel from the CN 110 to the MS 102, and be mapped onto the appropriate service instance by the PDSN 103.

At a later point in time, the MS 102 may terminate the videoconference including the chat board service by sending a SIP BYE message 164 to the CN 110, which message terminates the entire videoconference data session. The PDSN 103 may be notified of the terminated data session via a special COPS DECISION message 192, initiated by the P-CSCF 104 and triggered by the receipt of the SIP BYE message 164, wherein the message 192 may comprise a Remove command with parameters associated to the terminated data session, so that the PDSN 103 is notified of the terminated data session and can uninstall the packet filters 145 and 188, and also terminate any context and accounting related to that session. Knowing that the session is ended, the PDSN 103 also sends to the AAA server 108 an Accounting Stop message 170 for terminating the accounting session.

Terminating Session Establishment

According to a second preferred embodiment of the present invention, the packet filters for data flow mapping in the PDSN 103 can be transmitted for a data session terminated at the MS 102. When an incoming SIP Invite message is received by the P-CSCF from the CN desiring to establish a packet data session with the MS 102, the P-CSCF 104 processes and sends the message to the MS 102. The MS 102 establishes one or more service instances with the PDSN through the RAN. The PDSN 103 further indicates to the P-CSCF 104 that a bearer is established for the SIP session, and sends the identity of the service instances to the P-CSCF. The P-CSCF 104 will send a response back to the PDSN 103 acknowledging the setup of the bearer and includes in its response packet filters 145 for the data flows, as described hereinbefore. The PDSN 103 receives the packet filters 145 and installs them. When it receives data packets corresponding to the packet filter 145 signalled by the P-CSCF 104, the PDSN 103 forwards the traffic to the corresponding service instance.

With reference being made back to FIG. 1, the establishment of a terminating data session that originates from the CN 110 and terminates to the MS 102 can be carried on in a manner similar to the one described therein, except for the fact that it is the CN 110 that initiates the SIP setup by sending the initial INVITE message 112 to the MS 102, and not vice versa. This engenders a reverse direction of the SIP signalling for establishing the exemplary videoconference data session. Apart form the SIP signalling scheme, the provisioning of the data flow packet filters from the P-CSCF 104 to the PDSN 103, as well as the gathering of information leading to the creation of the packet filters, actions 120, 130, 140, 142, is performed in a manner similar to the one described hereinbefore in relation to the establishment of the originating scenario.

Therefore, with the current invention applied to both an originating and a terminating data session carried by an MS registered with a PDSN, it becomes possible to signal packet data filters for data flow mapping from the P-CSCF to the PDSN without involving a separate signalling sequence from the MS.

Based upon the foregoing, it should now be apparent to those of ordinary skills in the art that the present invention provides an advantageous solution for sending packet data filters to the PDSN. Although the system and method of the present invention have been described in particular exemplary reference to a CDMA2000 network, it should be realized upon reference hereto that the innovative teachings contained herein are not necessarily limited thereto and may be implemented advantageously with any wireline or wireless (or a combination there between) packet data network, beyond the CDMA2000 example stated herein, such as for example but not limited to: GPRS, eGPRS systems or UMTS (WCDMA) networks. For example, the MS 102 described in FIGS. 1 and 2 may be any kind of IP-based terminal (e.g. PC, laptop, Handheld device, PDA, Mobile Node, etc), while the PDSN 103 may be any type of Packet Data Access Node (PDAN) for an IP-based terminal, such as for example GGSN, SGSN, or any IP router performing accounting functions. Furthermore, the P-CSCF 104 described herein may comprise a Proxy SIP server functioning to support SIP-based services for the terminal/MS 102. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for provisioning a Packet Data Access Node (PDAN) with a packet filter for mapping one or more incoming data flows destined to a terminal to one or more service instances established between the PDAN and the terminal, the method comprising the steps of:
a) creating the packet filter in a Proxy-Call State Control Function (P-CSCF);
b) transmitting the packet filter from the P-CSCF to the PDAN; and
c) installing the packet filter in the PDAN.

2. The method of claim 1, further comprising the step of:
d) using the packet filter, mapping by the PDAN the one or more data flows originated by a Corresponding Node (CN) in communication over a packet data session with the terminal onto the one or more service instances.

3. The method of claim 2, further comprising the step of:
e) establishing the packet data session between the CN and the terminal;
wherein the packet filter is associated to the packet data session.

4. The method of claim 3, wherein step e) is performed using Session Initiation Protocol (SIP), and the P-CSCF comprises a Proxy SIP (PSIP) server.

5. The method of claim 3, wherein step a) comprises the step of:
a.1) in the P-CSCF, using information related to the:
an IP address of the CN;
one or more CN port numbers used for carrying out the data session;
a type associates with each of the one or more data flows; and
the one or more service instances;
for creating the packet filter.

6. The method of claim 5, wherein the P-CSCF receives the information for creating the packet filter during the packet data session setup.

7. The method claimed in claim 1, wherein the PDAN is a Packet Data Service Node (PDSN) of a CDMA2000 wireless network, and the terminal is a Mobile Station (MS).

8. The method of claim 3, further comprising the steps of:
f) during the packet data session, creating a new packet filter in the P-CSCF;
g) transmitting the new packet filter from the P-CSCF to the PDAN; and
h) installing the new packet filter in the PDAN.

9. The method of claim 3, further comprising the steps of:
f) terminating the packet data session; and
g) uninstalling the packet filter from the PDAN.

10. A Proxy-Call State Control Function (P-CSCF) for provisioning a Packet Data Access Node (PDAN) with a packet filter for mapping one or more incoming data flows destined to a terminal to one or more service instances established between the PDAN and the terminal, the P-CSCF acting to create the packet filter and to transmit the packet filter to PDAN.

11. The P-CSCF of claim 10, wherein the P-CSCF participates to an establishment of a packet data session associated with the data flows between a Corresponding Node (CN) and the terminal;
wherein the packet filter is associated to the packet data session, and the data flows are part of the packet data session.

12. The P-CSCF of claim 11, wherein the establishment of the packet data session is performed using Session Initiation Protocol (SIP), and the P-CSCF comprises a Proxy SIP (PSIP server.

13. The P-CSCF of claim 11, wherein for creating the packet filter the P-CSCF uses information related to the:
an IP address of the CN;
one or more CN port numbers used for carrying out the data session;
a type associates with each of the one or more data flows; and
the one or more service instances.

14. The P-CSCF of claim 13, wherein the P-CSCF receives the information for creating the packet filter during a setup of the packet data session.

15. The P-CSCF of claim 11, wherein the PDAN is a Packet Data Service Node (PDSN) of a CDMA2000 wireless network and the terminal is a Mobile Station (MS).

16. The P-CSCF of claim 11, wherein during the packet data session, the P-CSCF creates a new packet filter and transmits the new packet filter to the PDAN.

17. The P-CSCF of claim 11, wherein the P-CSCF participates to a termination of the packet data session and instructs the PDAN to uninstall the packet filter.

18. A packet data network comprising:
Packet Data Access Node (PDAN); and
a Proxy-Call State Control Function (P-CSCF) creating a packet filter for mapping one or more incoming data flows destined to a terminal to one or more service instances established between the PDAN and the terminal, and transmitting the packet filter to the PDAN;
wherein upon receipt of the packet filter, the PDAN installs the packet filter.

19. The packet data network of claim 18, wherein the PDAN uses the packet filter to map the one or more data flows originated by a Corresponding Node (CN), in communication over a data session with the terminal, onto the one or more service instances.

20. The packet data network of claim 19, wherein a packet data session is established between the CN and the terminal, and the packet filter is associated to the packet data session.

21. The packet data network of claim 20, wherein the packet data session is established using Session Initiation Protocol (SIP), and the P-CSCF comprises a Proxy SIP (PSIP server.

22. The packet data network of claim 20, wherein for creating the packet filter the P-CSCF, uses information related to the:
an IP address of the CN;
one or more CN port numbers used for carrying out the data session;
a type associates with each of the one or more data flows; and
the one or more service instances.

23. The packet data network of claim 22, wherein the P-CSCF receives the information for creating the packet filter during a setup of the packet data session.

24. The packet data network claimed in claim 18, wherein the PDAN is a Packet Data Service Node (PDSN), and the packet data network is a CDMA2000 wireless network and the terminal is a Mobile Station (MS).

25. The packet data network of claim 20, wherein during the packet data session, the P-CSCF creates a new packet filter and transmits the new packet filter to the PDAN, wherein upon receipt of the new packet filter the PDAN installs the new packet filter.

26. The packet data network method of claim 20, wherein when the packet data session is terminated, the PDAN uninstalls the packet filter.
